(19) United States
(12) Patent Application Publication
(10) Pub. No.: US 2015/0110943 A1
(43) Pub. Date: Apr. 23, 2015

(54) Process of Preparing Fresh Unpasteurized Juice

(71) Applicant: Rachan Malhotra, Washington, DC (US)

(72) Inventor: Rachan Malhotra, Washington, DC (US)

(21) Appl. No.: 14/521,122

(22) Filed: Oct. 22, 2014

Related U.S. Application Data
(60) Provisional application No. 61/894,257, filed on Oct. 22, 2013.

(51) Int. Cl. A23L 2/04

(52) U.S. Cl. CPC A23L 2/04; A23V 2002/00
USPC 426/599

(57) ABSTRACT

A process of preparing a fresh unpasteurized juice product combining cooked and raw produce to maximize bio-availability of nutrients. The juice product is prepared by pre-treating ingredients, including a fruit and herbs, by keeping them at a temperature between 41 F and 45 F until the ingredients are ready to be juiced. The ingredients are then crushed in a cold-press juicer to extract pulp without losing its nutrients. The pulp is then allowed to sit for a predetermined period of time to enable mixing of the nutrients to form new compounds that work synergistically for healing and boosting immunity. The process further includes filtering the pulp. Sour produce is added as a preservative to increase the shelf life of the juice.

### FIELD

The present invention is in the technical field of nutrition. More particularly, the present invention is in the technical field of preparing unpasteurized juices.

### BACKGROUND

Fruit and vegetable juice consumption continues to increase in part because of technological change in juice processing and concentration methods. Flash pasteurization, improved thermal concentrating, freeze concentrating, blending, freezing, and drying or crystallization all contributed to this growth by providing better quality, better tasting and higher purity juice products which are more convenient to use. The current health awareness by consumers has also contributed to the consumption of fruit juices and other natural beverages. However, in a conventional commercial process, fruit pulp is removed from juice, pasteurized, finished (juice removed), and frozen for storage. The conventional methods of fruit processing leads to the loss of a wide variety of enzymes, vitamins, phytonutrients and other nutrients from the final product. In addition, the added chemical preservatives may cause health problems to the users.

Conventional nutritional products, such as vitamin pills, cooked foods and fresh foods, are either low in enzyme activity or exceedingly difficult to assimilate into the modern lifestyle. It is difficult to eat fresh foods that have enzymes regularly because they take a lot of effort logistically. Eating such foods typically requires several hours of work every week in purchasing, cleaning and prepping. The difficulties of eating fresh produce are multiplied with larger variety of produce. Not many studies have been done to prove that certain prepping mechanisms enhance produce in unique ways such as acting each other synergistically to promote healing and boost immunity. In addition, not many products are available on the market particularly suited for each single person, as one's body rejects certain foods and accepts other foods more readily. It is well known that fruit and vegetables are an important source of micronutrients such as vitamins and minerals. Heat processing of vegetables or fruit, as is commonly applied in the food industry, can have an impact on the levels of these vitamins in the final product as well as on their oral bioavailability.

The challenge of producing a fruit juice product which is acceptable to a broad range of consumers, involves making a unique product having acceptable flavor, i.e. taste; distinctive aroma, i.e. smell; acceptable appearance, i.e. sight; satisfactory mouthfeel, i.e. touch; and filled with vitamins, enzymes and healthy nutrients. In order to have good quality fruit juices available year-round, the juice must be naturally processed without losing wide variety of enzymes, vitamins, phytonutrients and other nutrients present in the ingredients and must be naturally preserved for storage and distribution. Although conventional methods employed a freeze concentration process, the analytical data reveal that significant losses of volatile compounds including nutrients and enzymes were experienced. Moreover, because of the open processing used, oxidation products are produced thus an inferior quality juice is produced by employing conventional methods.

### SUMMARY OF THE INVENTION

It is an object of this invention to produce an unpasteurized fruit juice, which tastes as good as, or better than the starting juice.

A preferred object of this invention is to produce a fruit juice, which is substantially, rich in wide variety of enzymes, vitamins, phytonutrients and other nutrients present in the ingredients.

It is another object of the present invention is the use of a manufacturing process that eliminates the need for the freezing/chopping/thawing/chemical treating steps used in a conventional process.

It is another object of the present invention is to increase the shelf life of fruit juice greatly by using sour produce as preservatives.

It is yet another object of the present invention is to include one or more natural ingredients in the processing of the fruit juice for providing better taste and presence of healthy nutrients to the final product.

It is still another object of this invention to produce a fruit juice that can be used as a freshly made vegetable juice, which is lower in calories than fruit juices normally available in the grocery stores.

The fresh unpasteurized juice is produced from a plurality of ingredients treated in a specific manner by combining cooked and raw produce to maximize bio-availability of nutrients. All or a part of the plurality of ingredients are subjected to at least one pre-treatment process for the process of preparing the fresh unpasteurized juice product. The plurality of ingredients is stored at temperature between 41 F and 45 F before juicing. Then the ingredients are pressed inside a cold-press juicer for optimal extraction of a plurality of nutrients from the plurality of ingredients. The cold press juicer extracts the stored nutrients and enzymes from within the cell walls of each of the ingredients. The output of the cold-press juicer is a pulp of the mix of all ingredients. The resulting pulp is then allowed to sit for five minutes. This allows a variety of enzymes, vitamins, phytonutrients and other nutrients to combine with each other to form new compounds that work synergistically to promote healing and boost immunity. The juice is unpasteurized and it provides vitamins, minerals, enzymes, phytochemicals and other nutrients essential to healing. The pulp is then pressed using a hydraulic press and a filter cloth to obtain the fresh unpasteurized juice. The filter cloth has minute openings that separate juice from the pulp. Sour produce such as lime or lemon is added to pulp during pressing. The juice of such produce can act as a natural preservative to elongate the shelf life of the juices. The juice is bottled in a glass jar of sufficient capacity and the bottled juice is immediately refrigerated to a temperature between 35 F and 41 F. The glass jar has a plastic cap to hold the juice airtight. This ensures that the juice does not spill if the jar were to topple or if it were held in horizontal position. The glass jar is filled to the top to reduce degeneration of enzymes by air. The juice is kept at temperatures between 35 F and 41 F during storage and transportation.

In a broad embodiment, the present invention is a fresh unpasteurized juice extracted from raw and cooked produce. The advantages of the unpasteurized juice include the following: it has enzymes, it tastes good, it is convenient for the consumer and it is exceedingly easy to transport. The fresh unpasteurized juice is easy to drink on a regular basis and includes a large variety of nutrients that most people rarely ingest in their lifetime.

### BRIEF DESCRIPTION OF THE DRAWINGS

FIG. 1 illustrates a flow chart showing a process of preparing a fresh unpasteurized juice product according a preferred embodiment of the present invention.

FIG. 2 illustrates a flow chart showing a process of preparing a fresh unpasteurized juice product according to a second process of the present invention.

### DETAILED DESCRIPTION

The first step in obtaining the primary juice stream is to select processable fruit. As used herein, the term “processable fruit” refers to fruit, which can be processed with commercial juice extraction and finishing equipment to provide the unpasteurized juice product. The term “fruit juice raw material” or “plant product” or “fruit” or “fresh produce” as used herein refers to an edible plant or an edible part of a plant. Examples of plants from which the present plant material can be derived include fruit, vegetables, herbs and spices. The term “fresh plant material” or “fresh produce” as used herein refers to a plant material that after harvesting has not been preserved by drying or retorting. The term “fresh produce” does encompass plant material that has been preserved by freezing. The term “cooking” or “steaming” as used herein refers to the heating of pieces of plant material in order to substantially soften the cell structure within these pieces. Thus, the cooked pieces of plant material are considerably softer than the original uncooked pieces. This ensures for the easy retrieval of nutrients from the cell walls of the fresh fruit of plant product by crushing the walls of the cells. Except in the operating and comparative examples, or where otherwise explicitly indicated, all numbers in this description indicating amounts or ratios of material or conditions of reaction, physical properties of materials and/or use are to be understood as modified by the word “about”.

Following is a more detailed description of the process for making the unpasteurized juice product according to the preferred embodiment of the present invention. A plurality of nutrients present in a plant product or fruit is trapped in the cell walls of the plant product. For retrieving the plurality of nutrients present in the cell walls, a cold press juicer is employed in the preferred embodiment of the present invention. The cold press juicer crushes a plurality of ingredients or fresh produce and breaks their cell walls to release the nutrients trapped in the cell walls. Initially, before starting the juicing of the plurality of ingredients including the fruit product, the fresh produce are stored and kept at a temperature between 41 F and 45 F until they are ready to be juiced. In an embodiment of the present invention the juice is obtained by pressing at least one green leafy vegetable with the fruit. In such cases the green leafy vegetables are steamed for a predetermined period of time, which increases bio availability of a plurality of nutrients, and then rinsed in cold, running water to remove all the impurities produced during steaming process. After washing the green leafy vegetables, they are stored and kept at a temperature between 41 F and 45 F until they are ready to be juiced. The first pre-treatment regime for the fresh produce increases the bioavailability of the nutrients contained in the raw material.

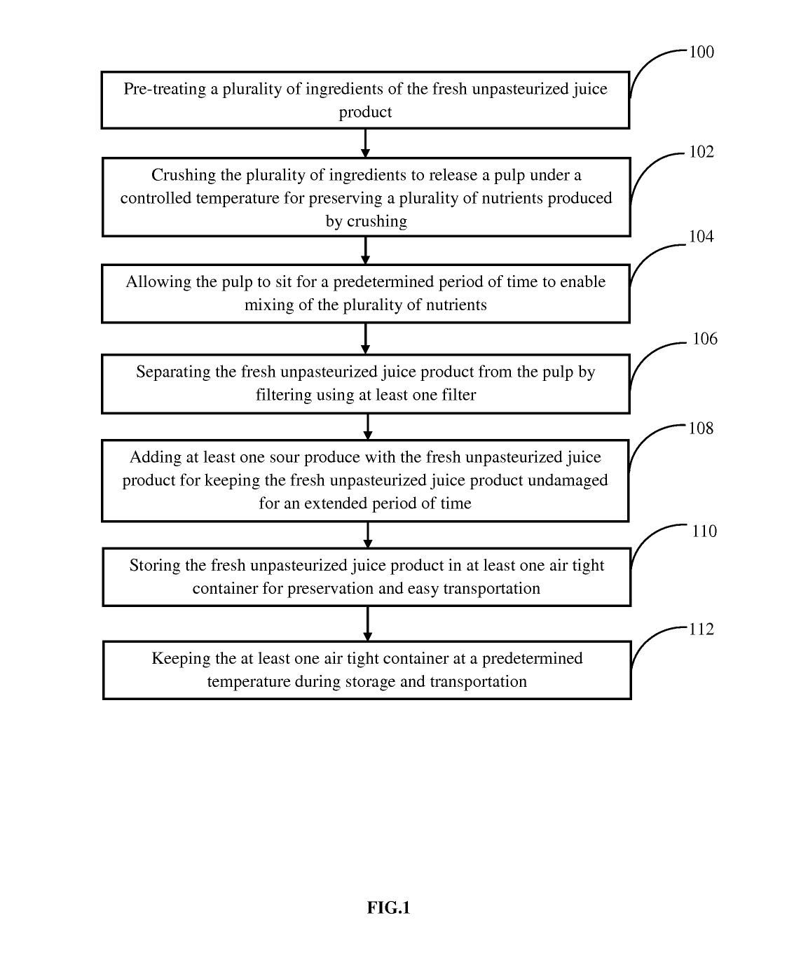

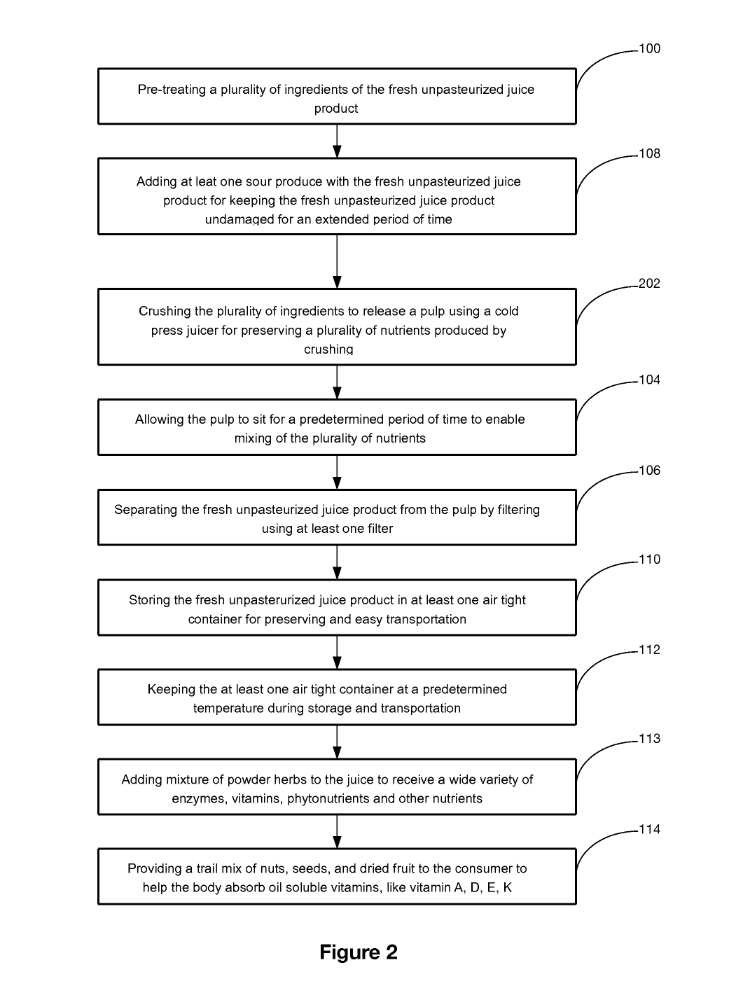

The process of producing unpasteurized juice product from different kinds of fresh produce, such as fresh fruits, herbs etc. comprise the above said pre-treatment processes. After completing the pre-treatment, according to a preferred embodiment of the present invention, the making of unpasteurized fruit juice product comprises the following processing steps. FIG. 1 illustrates a flow chart for preparing the unpasteurized fruit juice product from the plant product. As illustrated in block 100, the fresh plant material or fruit produce is first stored at temperature between 41 F and 45 F before juicing. In some embodiments the ingredients include green leafy vegetables and are subjected to a pretreatment process by steaming for a predetermined period of time and then rinsing in cold, running water. Then as illustrated in block 102, the plurality of ingredients is crushed under a controlled temperature to release a pulp containing a plurality of nutrients produced by crushing the cell walls of the fruit produce. Juice extraction can be carried out by any of the automatic juicing machines as in step 202 showin in FIG. 2, or by hand-squeezing the fruits or fresh plant materials, provided the cell walls of the fruit produce should be breached to release the nutrients and enzymes stored therein. The fruit produce is crushed to break their cell walls and release these nutrients. For extracting juice from the plant material, a cold-press juicer, such as ones made by Norwalk, is used in the preferred embodiment of the present invention. The nutrients and enzymes produced by breaking the cell walls of the plant material may easily be affected by the temperature produced by the crusher or juicer. The use of cold press juicer ensures that the heat generated during the crushing of the fruit produce does not destroy the nutrients and enzymes, which is done in a two-step process via shredding and later on pressed. In addition or optionally, a plurality of ice packs are used during the crushing of the cell walls and extracting the ingredients from the fruit produce to keep the temperature of the fruit produce between the permissible limits, thereby preserving the nutrients and enzymes from the temperature build up during the crushing process. In one embodiment of the present invention, the ice packs are placed on the top and tied to the walls of the cold-press juicer. Additionally, the ice packs are tied to the outside of the chute where pulp is released from the cold-press juicer, in addition to the icepacks placed on the top and side walls of the cold-press juicer. In another method, the ice packs are placed below the container that collects pulp, for controlling the temperature and thereby maximizing the availability of nutrients and enzymes from the plant material without getting lost in the temperature produced during the crushing process.

In yet another embodiment of the present invention, ingredients such as ginger and garlic is added to every juice pulp. The nutrients in ginger and garlic are scientifically proven to promote healing and boost immunity. In addition, ginger and garlic have nutrients that work synergistically to promote healing and boost immunity. Further, the pulp produced from the cold-press juicer is allowed to sit for a predetermined period of time as shown in block 104. This short period of time, preferably at least 5 minutes, allows the nutrients to combine with each other to form new compounds that work synergistically for healing and boosting immunity. The pulp produced is unpasteurized and provides vitamins, minerals, enzymes, phytochemicals and other nutrients essential to healing. As described in block 106, the pulp extracted from the cold-press juicer is pressed using a hydraulic press mechanism associated with the cold-press juicer to separate the juice from the pulp. The pulp is pressed against a filter cloth having a plurality of minute openings by the hydraulic press mechanism. The liquid juice is extracted from the pulp by the filter cloth. The filter cloth separates the insoluble items from the pulp. The size of the plurality of minute openings in the filter cloth controls both the quantity and the size of the pulp desired in the juice. During this separation of the juice using the hydraulic press mechanism a sour produce such as lime or lemon or a natural preservative is added to the juice for keeping the juice undamaged for an extended period of time as illustrated in block 108 of FIG. 1. While the sour produce can be added after separation of the juice as in step 108 in FIG. 1, the sour produce can be alternatively added before crushing the ingredients as in step 108 of FIG. 2.

In an embodiment of the present invention, natural preservatives including lime or lemon are added to pulp during hydraulic pressing. The juice of such natural preservatives has been scientifically proven to elongate the shelf life of juices. As shown in block 110, the juice is then bottled in a glass jar of sufficient capacity. The juice product is kept airtight by using a closure, preferably a plastic cap, with the glass jar. This ensures that the juice does not spill if the jar were to topple or if it were held in horizontal position. The glass jar is filled to the top to reduce degeneration of enzymes by air. Finally, as depicted in block 112, the juice in glass jar is immediately refrigerated to a temperature between 35 F and 41 F after bottling, to preserve the contents in the glass jar for a long period. The juice in glass jar is then transported to the various customers' locations in a cooler that can be made of different materials, such as Styrofoam or plastic, which will keep the temperature of the juice stored in the glass jar between 35 F and 41 F during transportation. The cooler is filled with ice packs to maintain the temperature of juice between 35 F and 41 F. The cooler is designed to be strong enough to hold the weight of both the juice jar and the ice packs for keeping the temperature between 35 F and 41 F.

Specific combinations of ingredients are used for achieving different varieties of juices according to alternate embodiments of the present invention. The following are specific illustrations of the ingredients for different types of juices according to the present invention:

### Example 1

According to an embodiment of the present invention the ingredients used for this specific type of juice includes at least ⅓^{rd} cucumber, ½ stalk celery, 2 stems cilantro, 1 apple, small pieces of ginger/garlic, 3 spoons sprouts, ¼ bunch spinach and 1 table spoon of lemon juice. All ingredients except lemon are crushed to make the pulp. Spinach is washed in running water and steamed for five minutes before the crushing process. By filtering the pulp inside the hydraulic press using a filter, juice of very high nutritional value is obtained. Small amount of lemon juice is added as a preservative to keep the juice undamaged for an extended period of time. The addition of herbs with the juice makes the juice more healthy and of high nutritional value. The juice is stored in glass jars and maintained and transported at a particular temperature between 35 F and 41 F and made available to the consumers. The users may receive a wide variety of enzymes, vitamins, phytonutrients and other nutrients from the juice.

### Example 2

According to another embodiment of the present invention the ingredients used for this specific type of juice includes 1+⅓^{rd} apples, small pieces of ginger/garlic, 3 spoons sprouts, ⅙^{th} red bell pepper, 2 stems mint, 5 large carrots and 1 table spoon lemon juice. All ingredients except lemon are crushed to make the pulp. By filtering the pulp inside the hydraulic press using a filter, the juice with of very high nutritional value is obtained. Small amount of lemon juice is added as a preservative to keep the juice undamaged for an extended period of time. The juice is stored in glass jars and maintained and transported at a particular temperature between 35 F and 41 F and made available to the consumers. The users may receive an unpasteurized and tasty juice with a wide variety of enzymes, vitamins, phytonutrients and other nutrients.

### Example 3

Yet another embodiment of the present invention proposes the ingredients used for another specific type of juice, which includes 1 apple, small pieces of ginger/garlic, 3 spoons sprouts, 2 stems parsley, ½ stem celery, ½ romaine lettuce and 1 table spoon lemon juice. All ingredients except lemon are crushed to make the pulp. By filtering the pulp inside the hydraulic press using a filter, the juice with of very high nutritional value is obtained. Small amount of lemon juice is added as a preservative to keep the juice undamaged for an extended period of time. The juice is stored in glass jars and maintained and transported at a particular temperature between 35 F and 41 F and made available to the consumers. The users may receive a wide variety of enzymes, vitamins, phytonutrients and other nutrients directly from the juice.

### Example 4

According to yet another embodiment of the present invention the ingredients used for another specific type of juice includes at least 1 apple, small pieces of ginger/garlic, 3 spoons sprouts, 2 stems cilantro, small pieces beet, 3 leaves of kale, 2 large carrots and 1 table spoon lemon juice. All ingredients except lemon are crushed to make the pulp. The kale leaves are washed in running water and steamed for ten minutes before being introduced into the process of preparing the juice. By filtering the pulp inside the hydraulic press using a filter, the juice with of very high nutritional value is obtained. Small amount of lemon juice is added as a preservative to keep the juice undamaged for an extended period of time. The juice is stored in glass jars and maintained and transported at a particular temperature between 35 F and 41 F and made available to the consumers.

### Example 5

According to another embodiment of the present invention the ingredients used for this specific type of juice includes 1+⅓^{rd} apples, 2 leaves of collards (steamed for 10 minutes), 1 slice fennel, 1 stem bok choy, small pieces of ginger/garlic, 3 spoons sprouts, ½ romaine lettuce and one table spoon lemon juice. All ingredients except lemon are crushed to make the pulp. Leaves of collards are washed and steamed for 10 minutes before adding to the process. The juice received by filtering the pulp inside a hydraulic press using a filter is healthier and with very high nutritional value. A small amount of lemon juice is added as a preservative to keep the juice undamaged for an extended period of time. The additives makes the juice more tasty, more healthy and of high nutritional value. The juice is stored in an air tight can or glass jar and kept at a temperature between 35 F and 41 F and can easily be transported.

### Example 6

According to another embodiment of the present invention the ingredients used for a new type of juice flavor comprises 1 apple, small pieces of ginger/garlic, 3 spoons sprouts, 2 stems mint, 3 leaves Red Swiss Chard, top off with cucumber and 1 table spoon lemon juice. All ingredients except lemon are crushed to make the pulp. The leaves of Red Swiss Chard are steamed for five minutes for the before introducing into the process of forming the pulp. A small amount of lemon juice is added as a preservative to keep the juice undamaged for an extended period of time. The final product is packed inside an airtight container and is kept at safe temperatures, preferably between 35 F and 41 F, and is made available to consumers.

### Example 7

In a yet another embodiment of the present invention the pulp is formed by pressing at least 1/9^{th} red cabbage which is subjected to steam for at least 10 minutes, 2 stems parsley, ⅕^{th} bunch Rapini, small pieces of ginger/garlic, 3 spoons sprouts and ⅙^{th} watermelon inside a cold-press juicer till the nutritional contents from the cell walls of the contents are extracted. The red cabbage is washed in running water and steamed for five minutes before the crushing process. The resulting pulp obtained is filtered and juice is separated to which 1 tablespoon lemon juice is added as a preservative to keep the juice undamaged for a long time within an airtight container. The container may be an airtight glass jar and kept at temperature between 35 F and 41 F for preserving the nutritional value of the juice.

### Example 8

According to another embodiment of the present invention, the ingredients for preparing the juice consisting of at least 1 apple, 1 yellow squash, ⅛^{th} yellow bell pepper, 2 stems cilantro, small pieces of ginger/garlic, 3 spoons sprouts, ⅛^{th} pineapple and 1 table spoon lemon juice. All ingredients except lemon are crushed to make the pulp. The yellow squash is steamed for five minutes, before adding the process of producing the pulp. A little amount of lemon juice is added with the pulp and is filtered using a filter inside a hydraulic press attached with the cold-press juicer. The small amount of lemon juice increases the shelf life of the juice. The final non-pasteurized juice received has a wide variety of enzymes, vitamins, phytonutrients and other nutrients.

In the above said example processes, the steamed plant part is immediately rinsed under running cold water to remove impurities and compounds released during steaming. This produce is then stored at temperature between 41 F and 45 F until they are ready to be juiced.

In some embodiments, in addition to the above said ingredients a small amount of powdered herbs may also be added as in step 113. The volume contents of the powdered herbs may include 1 part freshly crushed black pepper, 11 parts turmeric powder, 22 parts Cinnamon powder, 44 parts Amla powder, 11 parts Haritaki powder and 11 parts Bheritaki powder. The resulting fresh unpasteurized juices enable the plurality of users to receive a wide variety of enzymes, vitamins, phytonutrients and other nutrients. In addition to the powdered herbs, or optionally, the juice when provided to the consumer will include a packet of trail mix of nuts, seeds, and dried fruit to help the body absorb oil soluble vitamins, like vitamin A, D, E, K, etc. as in step 114. While the powdered herbs can be added to the juice, the powdered herbs can be provided separately to the consumer in a packet to be added to the jar of juice.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit.

Although the following description of the process of this invention is described with particular reference to making an unpasteurized orange juice as an example, it will be understood that the process is not limited thereto. Thus, the process of producing unpasteurized pulp or juice includes different kinds of other fruits, such as cucumber, lemon, cabbage, apple, etc.

1. A method of preparing unpasteurized juice comprising:
pre-treating at least one ingredient from a set of ingredients;
crushing the ingredients into a pulp using a press juicer to release nutrients;
having the pulp sit for a predetermined time to have the nutrients mix with each other; and
separating the juice from the pulp by filtering the pulp.

2. The method of claim 1, wherein the step of pre-treating comprises:
steaming at least one of the ingredients for a predetermined time;
washing the at least one of the ingredients with cold water; and,
storing the at least one of the ingredients between 41 F and 45 F.

3. The method of claim 2, wherein the step of separating comprising
placing the pulp in a filter cloth; and,
pressing the pulp in the filter cloth using the press juicer.

4. The method of claim 3, further comprising the steps of:
storing the juice in at least one air tight container for preservation and transportation; and,
keeping the air tight container at a predetermined temperature during storage and transportation.

5. The method of claim 4, further comprising the step of providing a mix of powdered herbs to the juice.

6. The method of claim 5, further comprising the step of providing a mix of nuts and seeds to provide essential oils to the juice.

7. A method of preparing unpasteurized juice comprising:
storing ingredients between 41 F and 45 F;
steaming at least one of the ingredients for a predetermined time;
washing the at least one of the ingredients with cold water;
crushing the ingredients into a pulp using a press juicer to release nutrients;
having the pulp sit for a predetermined time to have the nutrients mix with each other;
placing the pulp in a filter cloth;
pressing the pulp to separate the juice from the pulp by filtering the pulp;
adding at least one sour produce to the juice before the crushing step or after the pressing step to keep the juice undamaged for an extended time.

8. The method of claim 7, further comprising the steps of:
storing the juice in at least one air tight container for preservation and transportation at a temperature of 35-41 F.

9. The method of claim 8, further comprising the step of providing a mix of powdered herbs to the juice.

10. The method of claim 8, further comprising the step of:
providing 1 part, per volume, of crushed black pepper;
providing 12 parts, per the volume, of turmeric powder;
providing 22 parts, per the volume, of cinnamon powder;
providing 44 parts, per the volume, of amla powder;
providing 11 parts, per the volume, of haritaki powder; and,
providing 11 parts, per volume, of bheritaki powder.

11. The method of claim 9, further comprising the step of providing a mix of nuts and seeds to provide essential oils to the juice.

12. A method of preparing unpasteurized juice comprising:
providing one apple, ginger, garlic, three spoons of sprouts, two stems of cilantro, three leaves of kale, and two large carrots as ingredients;
steaming the three leaves of kale for a predetermined time;
washing the steamed kale with cold water;
storing the ingredients between 41 F and 45 F;
crushing the ingredients into a pulp using a press juicer to release nutrients;
having the pulp sit for a predetermined time to have the nutrients mix with each other;
separating the juice from the pulp by filtering the pulp; and,
adding at least one sour produce to the juice before the crushing step or after the separating step to keep the juice undamaged for an extended time.

13. The method of claim 12, wherein the step of separating comprising
placing the pulp in a filter cloth; and,
pressing the pulp in a cold press juicer.

14. The method of claim 13, further comprising the steps of:
storing the juice in at least one air tight container for preservation and transportation; and,
keeping the air tight container at a predetermined temperature during storage and transportation.

15. The method of claim 14, further comprising the step of providing a mix of powdered herbs to the juice.

16. The method of claim 15, further comprising the step of providing a mix of nuts and seeds to provide essential oils to the juice.

17. The method of claim 14, further comprising the steps of
adding 1 part freshly crushed black pepper, 11 parts turmeric powder, 22 parts cinnamon powder, 44 parts amla powder, 11 parts haritaki powder and 11 parts Bheritaki powder, wherein the parts are per volume.

18. The method of claim 1, further comprising:
adding at least one sour produce to the juice before the crushing step or after the separation step to keep the juice undamaged for an extended time.

19. The method of claim 1, further comprising
adding at least one sour produce before the crushing step or after the separation step to the juice to keep the juice undamaged for an extended time;
storing the juice in at least one air tight container for preservation and transportation;
keeping the air tight container at a predetermined temperature during storage and transportation; and,
providing a mix of powdered herbs to the juice.

20. The method of claim 19, further comprising the step of providing a mix of nuts and seeds to provide essential oils to the juice.
